(19) United States
(12) Patent Application Publication
(10) Pub. No.: US 2015/0293040 A1
(43) Pub. Date: Oct. 15, 2015

(54) CALCULATION SYSTEM AND CALCULATION METHOD

(71) Applicant: HITACHI, LTD., Chiyoda-ku, Tokyo (JP)

(72) Inventors: Koji Aramaki, Tokyo (JP); Masanari Koguchi, Tokyo (JP); Miyako Matsui, Tokyo (JP)

(21) Appl. No.: 14/649,924

(22) PCT Filed: Dec. 5, 2012
(86) PCT No.: PCT/JP2012/081445

§ 371 Date: Jun. 5, 2015

(51) Int. Cl. G01N 23/04

(52) U.S. Cl. CPC G01N 23/04; G01N 2223/205; G01N 2223/401; G01N 2223/601; G01N 2223/631

(57) ABSTRACT

There is provided a calculating system that can calculate only a gradation image of only a measurement target in monitoring large-scale facility using a transmission imaging on the basis of a cosmic ray. In addition to a gradation image on the basis of a flight track of the cosmic ray, a gradation image of the density length on the basis of structure information of a structural object which is not a measurement target is made and used to correct the gradation image on the basis of the flight track of the cosmic ray.

### TECHNICAL FIELD

The present invention relates to a calculating system and a calculating method that calculate structure of structural objects.

### BACKGROUND ART

Recently, in order to inspect soundness of a large-scale structural object such as a power generating plant, piping or support members constituting the structural objects are subjected to a destructive test and a nondestructive test. Of the tests, the nondestructive test has an advantage in that the inspection is less likely to cause the soundness of the test target to be degraded, when compared with the case of the destructive test. Further, the nondestructive test also has an advantage in that it is not necessary to perform a restoring process after the performing of the test, and thus is applied to various structural objects. For example, as an element of a maintenance inspection for metallic piping which is appropriate for an industrial standard, a technique is used in which reflection of an ultrasonic pulse is used to measure thickness of a portion of a measurement target object, and thus a level of degradation relating to the internal portion of the piping can be figured out. However, in the case of this technique, because the ultrasonic vibrator comes directly in contact with the measurement target object, it is necessary to remove the coating material of the piping before the measurement and restore the removed coating material after the measurement. Therefore, there is a disadvantage in that a significant cost is required before and after the actual measurement.

Further, as shown in PTL 1, a technique is also used in which a radiation transmission imaging is performed to omit a process for removing and restoring the coating material of the piping. In this technique, an artificial radiation source and a detector are disposed in positions for interposing the measurement target object, respectively.

Further, PTL 2 describes a technique in which a muon that is a kind of natural radiation and a secondary cosmic ray of high energy is used to perform a transmission imaging on a furnace wall or a furnace bottom of an iron-making blast furnace, and thus a level of degradation relating to a refractory of the furnace can be figured out.

Further, PTL 3 describes a technique in which a property of the muon of the secondary cosmic ray during transmission through a measurement target is used, and thus a level of change in a quality of a material for a measurement target can be figured out.

### CITATION LIST

### Patent Literature

PTL 1: Japanese Patent No. 4814918

PTL 2: JP-A-2007-121202

PTL 3: JP-A-2011-123048

### SUMMARY OF INVENTION

### Technical Problem

In the technique shown in PTL 1, although it is possible to omit the process for removing and restoring a coating material, the transmission ability of the artificial radiation is poor and thus it is necessary to dispose a radiation source in the vicinity of a measurement target object. In a large-scale plant, there is a disadvantage in that since it is impractical that an artificial radiation source is permanently installed in the vicinity of all of measurement target objects, it is necessary to install and remove a radiation source and a detector for each measurement target object whenever a measurement is performed, and a significant cost is required before and after an actual measurement.

In the techniques shown in PTL 2 and PTL 3, a particle having extremely high transmission properties•rectilinearity is used and a density length of an object through which the flight path of the used particle goes is provided as a contrast image, and thus it is not necessary to essentially dispose a detector in the vicinity of a measurement target object unlikely the case of PTL 1. However, in most cases, there is a disadvantage in that a transmission image which is imaged reflects, on a contrast image, density lengths of a combination including not only a measurement target object but also other objects through which the flight path of the particle goes.

In light of the disadvantages of the related arts as described above (removing•restoring the coating material of the measurement target object, and installing•removing an artificial radiation source), the object of the present invention is to provide an apparatus or a method in which it is possible to obtain a contrast image reflecting the actual density length of only a desired measurement target object in performing a nondestructive test of which a purpose is to inspect soundness of a large-scale structural object or a part of the large-scale structural object.

### Solution to Problem

The summary of the invention for realizing the object disclosed in this application is as follows.

A calculating system according to the present invention includes: an imaging unit that images structure information of a certain section using a cosmic ray which is transmitted through a measurement target structural object and other structural objects; a structure information acquiring unit that has structure information of the other structural object; a density length calculating unit that determines whether or not the structure information of the other structural object is included as a measurement target and calculates a density length of a structure which is determined as a non-target; and an image computing unit that calculates the structure information of the measurement target structural object on the basis of the image which is imaged by the imaging unit and the density length of the structure which is determined as a non-target.

Further, a calculating system according to the present invention includes: a flight track acquiring unit that acquires a flight track of a cosmic ray which is transmitted through a measurement target and other structural objects; an imaging unit that performs imaging on the basis of the flight track of the cosmic ray; a first memory unit that retains information of the flight track of the cosmic ray, and a second memory unit that retains the structure information of the measurement target and the other structural object; and a density length calculating unit that calculates a gradation image of a first density length on the basis of the structure information of the other structural object, and calculates a gradation image of a second density length on the basis of the structure information of the measurement target and the structure information of the other structural object.

A calculating method according to the present invention includes: a first step of imaging structure information of a certain section using a cosmic ray which is transmitted through a measurement target structural object and other structural objects; a second step of acquiring structure information of the other structural object; a third step of determining whether or not the structure information of the other structural object is included as a measurement target; a fourth step of calculating a density length of a structure which is determined as a non-target in the third step; and a fifth step of calculating the structure information of the measurement target structural object on the basis of the image which is imaged in the first step and the density length which is calculated in the fourth step.

### Advantageous Effects of Invention

According to the present invention, it is possible to perform an appropriate nondestructive inspection with respect to a desired measurement target object.

### BRIEF DESCRIPTION OF DRAWINGS

FIG. 1 is a conceptual view exemplarily showing various objects existing on a flight path of a muon in the invention.

FIG. 2 is a view showing a configuration of a large-scale facility state monitoring system according to one embodiment of the invention.

FIG. 3 is a view showing an example of a screen of a user interface according to one embodiment of the invention.

### DESCRIPTION OF EMBODIMENTS

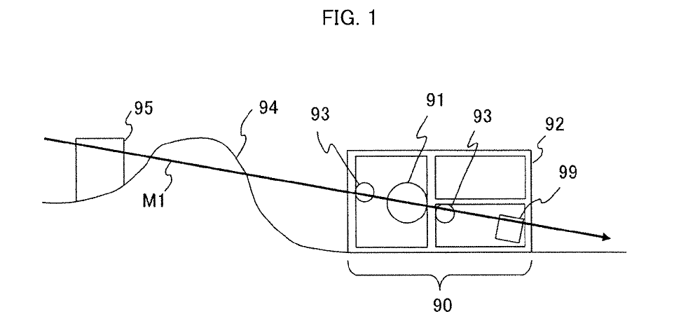

FIG. 1 is a view which the inventors of this application studied prior to the invention. In the drawing, a state is schematically shown as an example in which various non-measurement target objects exist on the path of arrow mark M1 corresponding to a flight path of a muon. For example, in a case where it is a purpose to perform a transmission imaging on a measurement target object 91 such as piping constituting a large-scale facility 90 through a muon detector 99, it can be seen that the flight path M1 also penetrates walls of a building 92 surrounding the measurement target object 91, a piping 93 other than the measurement target object 91, a mountain 94 outside the building 92 or other constructional structures 95.

In other words, the muon as the secondary cosmic ray is generated in the remote area corresponding to an upper layer of the earth atmosphere, and it is not uncommon that the travelling distance of the muon until the muon is incident on the detector exceeds 10 Km. Accordingly, it is considered that there are, on the flight path of the muon, non-measurement target objects having various materials and shapes, such as a building surrounding the measurement target object, walls or pillars constituting architectural structure in the external portions of the building, or earth and sand constituting a topography such as a mountain or a hill.

However, in the practical environment, it is difficult to figure out how those non-measurement target objects change during the measuring one by one. Accordingly, the obtained contrast image includes not only information on the basis of the object which is originally intended to be measured but also information of the non-measurement target object.

Hereinafter, the embodiment of the invention will be described with reference to the drawings.

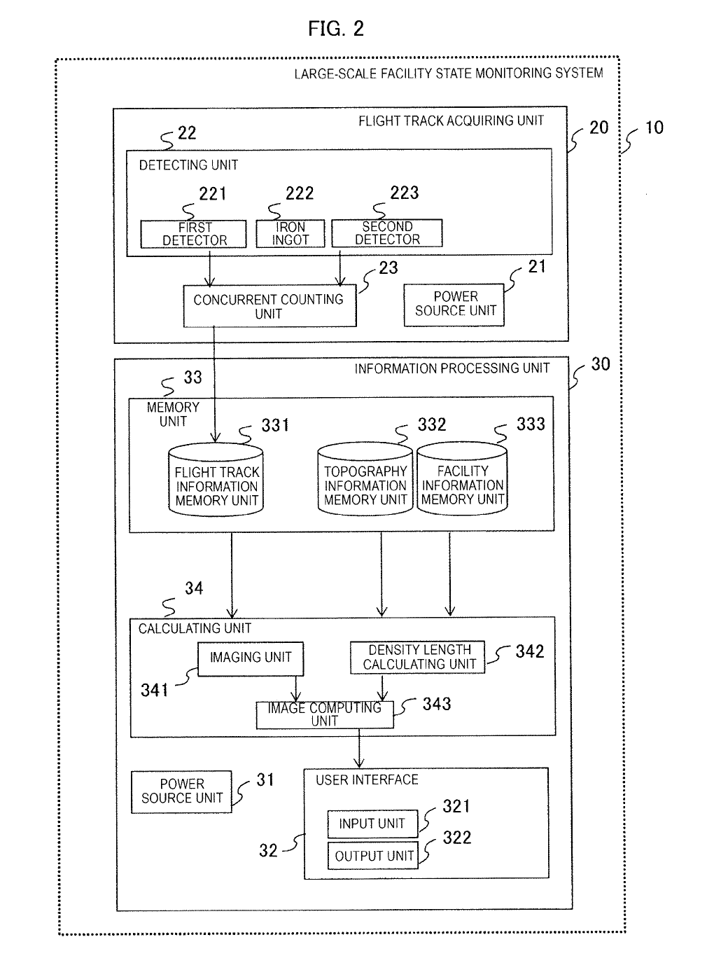

FIG. 2 is a view showing a configuration of a large-scale facility state monitoring system according to one embodiment of the invention.

A large-scale facility state monitoring system 10 of the embodiment includes a flight track acquiring unit 20 and an information processing unit 30 as constitutional elements.

Firstly, the flight track acquiring unit 20 will be described hereinafter.

The flight track acquiring unit 20 includes a power source unit 21, a detecting unit 22 and a concurrent counting unit 23 as constitutional elements.

The power source unit 21 corresponds to a power source unit which supplies necessary power to the detecting unit 22 and the concurrent counting unit 23.

The detecting unit 22 includes a first detector 221, an iron ingot 222 and a second detector 223 as constitutional elements.

Both of the first detector 221 and the second detector 223 correspond to a position sensitive detector. The position sensitive detector described herein can detect a coordinate value of a passing point in the detector when charged particles pass through the detector. A detector may be an example thereof in which a plurality of detecting elements (scintillator) is disposed in a plane-like shape to be a matrix, and a result of detection performed in a certain detecting element and a time relating to the result are simultaneously detected.

Further, when the charged particles pass through each of the first detector 221 and the second detector 223 respectively, the first detector 221 and the second detector 223 transmit the coordinate values of the passing points of the charged particles to the concurrent counting unit 23 after a constant and extremely-short delayed time. As for the dispositional relationship between the first detector 221 and the second detector 223, it is preferable that there is a relationship in which the plane-like detectors described above are disposed in parallel to each other. When there is an inclinational relationship in which a plane of the second detector is inclined with respect to a plane of the first detector, it is not possible to efficiently catch up the charged particles which are transmitted through the measurement target object and the first detector 221. Therefore, in order to prevent this problem, it may be also considered that a plane having a size greater than that of the first detector 221 is necessary. Accordingly, as the relationship between each plane is changed from the inclinational relationship to the parallel relationship, it is possible to increase the detection efficiency of the charged particles correspondingly.

Further, charged particles are incident on the detecting unit 22 in the directions of various orientation angles•zenith angles at irregular timings. These charged particles include not only the muon of high energy but also soft components such as electrons. The soft component is extremely inferior to the muon in rectilinearity thereof in objects. In order to obtain a contrast image on the basis of an exact density length of a measurement target object, it is necessary to selectively detect only muon of high rectilinearity.

Accordingly, the method of selectively detecting only muon will be described hereinafter. Firstly, in a case where charged particles which pass through the first detector 221 and are incident on the iron ingot 222 are the muon, it is possible for the second detector 223 to transmit a single coordinate value to the concurrent counting unit 23. This is because the muon intactly passes through the iron ingot 222, and then is incident on the second detector 223.

Whereas, in a case where the charged particles which pass through the first detector 221 and are incident on the iron ingot 222 are the soft component, the second detector 223 transmits a plurality of coordinate values to the concurrent counting unit 23 at an approximately concurrent time. This is because the particle thereof causes plural particles to be generated during the passing of the iron ingot 222 and proceeding directions of the generated particles are variously changed.

As described above, only a case where the second detector 223 detects the single coordinate value is selectively used, and thus it is possible to selectively detect only the muon, and, as a result, to exclude the influence of the soft component.

The concurrent counting unit 23 compares each time which is transmitted from the first detector 221 and the second detector 223 and determines that the same muon is passed only in a case where the difference between the compared times is in a certain range. Further, two sets of the coordinate values which are determined are transmitted to the information processing unit 30. As described below, on the basis of the two sets of the coordinate values which are determined as being a concurrent time, it is possible to obtain a track of a muon.

Hereinafter, the information processing unit 30 will be described below.

The information processing unit 30 includes a power source unit 31, a user interface 32, a memory unit 33 and a calculating unit 34 as constitutional elements.

The power source unit 31 corresponds to a power source unit which supplies necessary power to the user interface 32, the memory unit 33 and the calculating unit 34.

The user interface 32 includes an input unit 321 such as a keyboard or a mouse, and an output unit 322 such as a display device or a printer as constitutional elements. It is possible for an operator to perform the following operations through the user interface 32. For example, there are an operation of selecting one or more of desired items from options provided by the calculating unit 34, an operation of selecting a partial range from geometric shape shown by the calculating unit 34, an operation of selecting a certain numerical value from a definite range of numerical numbers provided by the calculating unit 34, an operation of inputting a value which can be substituted for variables provided by the calculating unit 34, and the like.

The memory unit 33 includes a flight track information memory unit 331, a topography information memory unit 332 and a facility information memory unit 333 as constitutional elements.

The flight track information memory unit 331 causes time information to be combined with two sets of muon passing coordinate data transmitted from the concurrent counting unit 23 whenever passing of the muon is generated, causes the combined result to become flight track (track) information, and newly stores the track information.

The topography information memory unit 332 retains geometrical data indicating topography around the large-scale facility 90 which includes measurement target objects as constitutional elements, and data indicating material or density relating to the topographical objects constituting the topography. Herein, the topographical objects include not only mountains, hills and the like which are formed naturally, but also constitutional elements such as structural objects including dams, tunnels, bridges, buildings, and the like which are artificially formed.

The facility information memory unit 333 retains geometrical shape data and material or density data relating to objects such as a door or a crane (for example, a set-type crane) which changes in position or shape thereof within a certain range, or objects such as a tank which stores an amount of fluid object varying within a certain range, in addition to static architectural members such as walls, pillars and beams which constitute the large-scale facility 90. Further, the facility information memory unit 332 retains data indicating various amounts of values to be changed in the certain range mentioned above and change ranges of the above amounts, and data indicating material or density of the fluid object described above.

The calculating unit 34 includes an imaging unit 341, a density length calculating unit 342 and an image computing unit 343 as constitutional elements.

The imaging unit 341 selects flight track information having time information corresponding to a time period, which an operator designates through the user interface 32, among plural pieces of the flight track information retained in the flight track information memory unit 331, and makes contrast images of measurement target object on the basis of the muon passing coordinate value data of the selected information. After this, the contrast image is represented as an actual survey image. The imaging unit 341 transmits actual image data to the image computing unit 343.

The density length calculating unit 342 makes a virtual contrast image using a method described later, on the basis of various data retained in the topography information memory unit 332 and the facility information memory unit 333. After this, the contrast image is represented as a virtual image.

The image computing unit 343 performs a computing which is designated by an operator through the user interface 32, with respect to the actual survey image transmitted from the imaging unit 341 and the virtual image transmitted from the density length calculating unit 342, and transmits the computed result to the user interface 32. The computing also includes handling the transmitted intact image as the computed result.

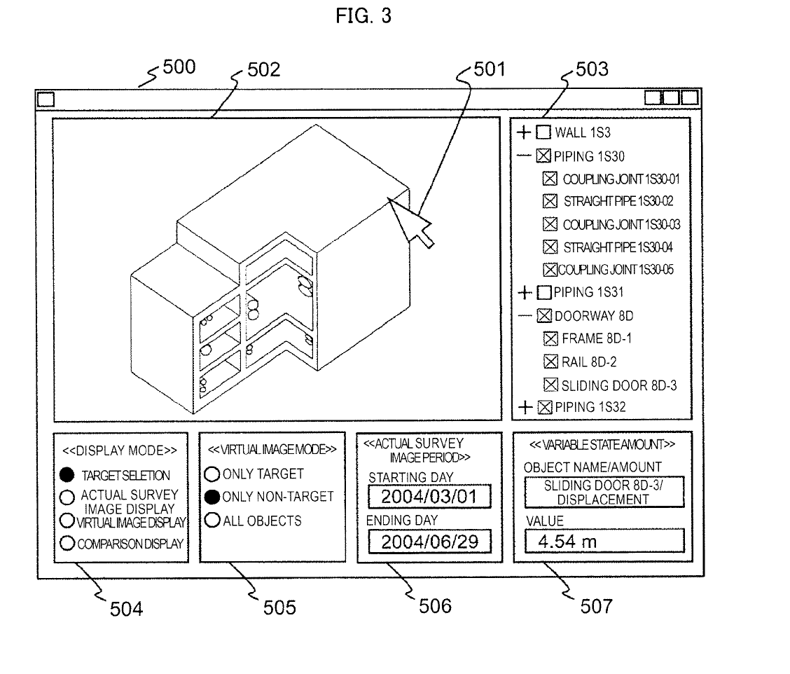

FIG. 3 is a view showing an example of a screen of the user interface 32. A screen 500 includes a mouse pointer 501, an image display unit 502, an object lookup display unit 503, a display mode selecting unit 504, a virtual image mode selecting unit 505, an actual survey image time designating unit 506, and a variable state amount designating unit 507. Further, the screen 500 causes various types of operations to be realized by an operator in cooperation with an input unit 321 such as a keyboard or a mouse.

As display modes, four options such as “target selection”, “actual survey image display”, “virtual image display” and “comparison display” are displayed on the display mode selecting unit 504, and an operator may select one of the display modes.

In a case where a selected display mode corresponds to “the target selection”, a drawing of the large-scale facility 90 is displayed on the image display unit 502. This drawing may be a view such as a plan view and a solid view capable of causing a state of the facility to be determined, and, for example, a total of four types of drawings which include plan views and a solid view seen from three directions may be combined in plural number to be displayed side by side. Further, the solid view may be displayed in the form of a sectional view taken out along with a certain plane.

Data for these drawings is retained in the facility information memory unit 333. Measurement target flags as attribute information for individual objects constituting the large-scale facility 90 are also retained in the facility information memory unit 333. The measurement target flag is a binary state variable indicating whether or not the object is the measurement target or the non-measurement target.

The object corresponding to the measurement target is highlighted in the shape of particular colors or in the form of flickering marks and the like on the drawing, and thus it is possible for the operator to easily identify the object. Identity names for individual objects constituting the large-scale facility 90 are displayed in the form of a lookup table on the object lookup display unit 503, a symbol is attached to each object according to the measurement target flag, or the identity names are distinguished using colors, and thus it is possible for the operator to easily indentify whether or not the object is the measurement target.

Further, the operator operates a mouse to select an object such as piping shown in a drawing, and thus the operator can change a measurement target flag of the object. Further, the identity name of the object can be operated through a mouse to also change the measurement target flag. The changed result is registered in the facility information memory unit 333.

In a case where the selected display mode is “actual survey image display” or “virtual image display”, an actual survey image or a virtual image transmitted from the image computing unit 343 is displayed on the image display unit 502, respectively.

In a case where the selected display mode is “comparison display”, a comparison image transmitted from the image computing unit 343 is displayed on the image display unit 502. Herein, the comparison image corresponds to, for example, a color image in which a blue contrast image as the actual survey image and a red contrast image as the virtual image are overlapped with each other, or an image representing a difference between the actual survey image and the virtual image. The computing between the actual survey image and the virtual image is performed by the image computing unit 343.

As virtual image modes, three options such as “only target”, “only non-target”, and “all objects” are displayed on the virtual image mode selecting unit 505, and an operator may select one of the virtual image modes.

In a case where the selected virtual image mode is “only target”, the density length calculating unit 342 calculates line segments that are generated when a virtual and linear muon flight track corresponding to each pixel is cut out by individual objects as the target corresponding to only objects in which the value of the measurement target flag corresponds to the measurement target, among the objects retained in the facility information memory unit 333. Further, a product between a line segment and a density of an object related to the line segment is defined as a density length of the object, and the sum of the density lengths for all of the objects as the targets is defined as a pixel value of the pixel. In this way, a density length for all of the pixels is obtained, and the obtained density length is, for example, normalized so as to make a contrast image which eventually becomes a virtual image.

Herein, the virtual and linear muon flight track is predetermined so that a correspondence relationship between the pixel and the virtual and linear muon flight track can coincide with a correspondence relationship between a pixel and a muon flight track which is actually detected when the imaging unit 341 makes an actual survey image. Further, as for the objects which change in position or shape thereof within a certain range, and the objects which store an amount of fluid object varying within a certain range, with reference to values such as a displacement which is retained in the facility information memory unit 333, the shapes of the objects are appropriately calculated and the calculated shapes are used when the virtual images are made.

Further, in a case where the selected virtual image mode is “only non-target” , the density length calculating unit 342 makes virtual images for all of the objects as the target in which the value of the measurement target flags corresponds to the non-measurement target, among the objects retained in the facility information memory unit 333 and for all of the objects as the target which are retained in the topography information memory unit 332. The specific making method is the same as that of the case where the virtual image mode is “only target”.

Further, in a case where the selected virtual image mode is “all objects”, the density length calculating unit 342 makes virtual images for all of the objects as the target which are retained in the facility information memory unit 333 and all of the objects as the target which are retained in the topography information memory unit 332. The specific making method is the same as that of the case where the virtual image mode is “only target”.

When the virtual image mode is set to be “only non-target” and the display mode is set to be “comparison display”, it is possible to exclude the influence of the non-measurement target object and provide the contrast image for only the measurement target object. Further, when the virtual image mode is set to be “all objects” and the display mode is set to be “comparison display”, it is possible to provide, in the form of a contrast image, information relating to a difference between a state of an actual object and the topography information and the facility information retained in the memory unit, and it is possible to provide assistance in finding construction failure or aging degradation.

The actual survey image time designating unit 506 is provided with inputting spaces for designating a time period for flight track information which is used when the imaging unit 341 makes an actual survey image. An operator may operate a keyboard or the like to perform the inputting, for example, in the form of a starting day and an ending day.

The variable state amount designating unit 507 is provided with inputting spaces for designating values such as displacement of each object, which are the values that are used when the density length calculating unit 342 makes the virtual image. For example, an operator may operate a keyboard and the like to designate a value “4.54 m” which corresponds to an amount such as “displacement” of a sliding door called “sliding door 89D3”.

Finally, according to the present invention, it is possible to perform a nondestructive test of which a purpose is to inspect soundness of piping and the like constituting a large-scale structural object such as a power generating plant, and thereby to obtain a contrast image reflecting the actual density length of only a desired measurement target object, without removing•restoring a coating material of a measurement target object and without installing•removing an artificial radiation source.

Further, according to the present invention, it is possible to obtain an image reflecting a difference between an actual state of a desired measurement target object and an ideal state of the design. As a result, it is possible to monitor soundness of a plant during a working process all the time, and it is possible to provide a plant having a high operation rate and stability.

### REFERENCE SIGNS LIST

10 Large-scale facility state monitoring system

20 Flight track acquiring unit

30 Information processing unit

90 Large-scale facility

91 Measurement target object

1. A calculating system comprising:
an imaging unit that images structure information of a certain section using a cosmic ray which is transmitted through a measurement target structural object and other structural objects;
a structure information acquiring unit that has structure information of the other structural object;
a density length calculating unit that determines whether or not the structure information of the other structural object is included as a measurement target and calculates a density length of a structure which is determined as a non-target; and
an image computing unit that calculates the structure information of the measurement target structural object on the basis of the image which is imaged by the imaging unit and the density length of the structure which is determined as a non-target.

2. The calculating system according to claim 1,
wherein the structure information of the measurement target structural object is a density length of the measurement target structural object.

3. The calculating system according to claim 1,
wherein the image computing unit evaluates degradation of the measurement target structural object using the structure information of the measurement target structural object.

4. A calculating system comprising:
a flight track acquiring unit that acquires a flight track of a cosmic ray which is transmitted through a measurement target and other structural objects;
an imaging unit that performs imaging on the basis of the flight track of the cosmic ray;
a first memory unit that retains information of the flight track of the cosmic ray, and a second memory unit that retains the structure information of the measurement target and the other structural object; and
a density length calculating unit that calculates a gradation image of a first density length on the basis of the structure information of the other structural object, and calculates a gradation image of a second density length on the basis of the structure information of the measurement target and the structure information of the other structural object.

5. The calculating system according to claim 4, further comprising:
an image computing unit that corrects an image which is imaged, on the basis of the image which is imaged by the imaging unit and the gradation image of the first density length, and that computes a gradation image indicating a difference between the image which is imaged and the gradation image of the second density length.

6. The calculating system according to claim 4,
wherein the flight track acquiring unit includes a first detector and a second detector which are disposed to interpose the measurement target, and a concurrent counting unit that is connected to the first detector and the second detector and counts intensity of the cosmic ray which is detected, and
wherein the concurrent counting unit determines whether or not the cosmic ray is a muon and acquires only a flight track of the cosmic ray which is determined as the muon.

7. A calculating method comprising:
a first step of imaging structure information of a certain section using a cosmic ray which is transmitted through a measurement target structural object and other structural objects;
a second step of acquiring structure information of the other structural object;
a third step of determining whether or not the structure information of the other structural object is included as a measurement target;
a fourth step of calculating a density length of a structure which is determined as a non-target in the third step; and
a fifth step of calculating the structure information of the measurement target structural object on the basis of the image which is imaged in the first step and the density length which is calculated in the fourth step.

8. The calculating method according to claim 7,
wherein the structure information of the measurement target structural object is a density length of the measurement target structural object.

9. The calculating method according to claim 7, further comprising:
a sixth step of evaluating degradation of the measurement target structural object using the structure information of the measurement target structural object.
